(19) United States
(12) Patent Application Publication
(10) Pub. No.: US 2016/0291545 A1
(43) Pub. Date: Oct. 6, 2016

(54) HOLOGRAPHIC THREE-DIMENSIONAL DISPLAY SYSTEM AND METHOD

(71) Applicant: AFC TECHNOLOGY CO., LTD., Shenzhen (CN)

(72) Inventors: Cheng FAN, Shenzhen (CN); Zhisen CAI, Shenzhen (CN); Chaochuan JIANG, Shenzhen (CN)

(21) Appl. No.: 15/182,151

(22) Filed: Jun. 14, 2016

Related U.S. Application Data
(63) Continuation of application No. PCT/CN2014/087594, filed on Sep. 26, 2014.

(51) Int. Cl. G03H 1/26; G03H 1/04; G02B 27/22

(52) U.S. Cl. CPC G03H 1/268; G02B 27/2214; G03H 1/0443; G03H 2223/19

(57) ABSTRACT

A holographic three-dimensional display system and a holographic three-dimensional display method are disclosed. Plane pixel information (J*K*M*N) of the flat panel display is reasonably used to convert the discrete spatial spectrum image information Iₘₙ into the discrete spatial spectrum image Sⱼₖ by using holographic coding conversion, the discrete spatial spectrum thereof is restored by using corresponding lens arrays, and the discrete spectrum widening of the sampling angle ωₘₙ is realized by the holographic function screen so as to realize complete spatial spectrum restoring of an original three-dimensional space. By using the lens arrays and the holographic function screen, an inherent conflict between the imaging quality of a microlens array and the resolution of a displayed three-dimensional image in integration photography is effectively overcome, and eye visible perfect true three-dimensional display is realized, thereby obtaining eye visible prefect true three-dimensional display.

PCT International Applications WO2010/072065, WO2010/072066 and WO2010/072067 are incorporated herein by reference in its entirety.

### BACKGROUND OF THE INVENTION

1. Field of the Invention

The present invention relates to a holographic three-dimensional display system and method.

2. Related Arts

Integrated photography (APPLIED OPTICS/Vol. 52, No. 4/1 February 2013) is theoretically an ideal three-dimensional light field collecting and display technology, but an inherent conflict between the imaging quality of a microlens array and the resolution of a displayed three-dimensional image is hard to overcome, namely, high resolution three-dimensional display requires the microlens array of a more fine size, but a microlens is too small and difficultly ensures subimage imaging quality of each lens, and a satisfactory true three-dimensional display effect is hard to obtain as so far. WO2010/072065, WO2010/072066 and WO2010/072067 disclose a real time color holographic three-dimensional display system and method, which use a digital holographic principle to realize eye visible true three-dimensional display by a common photography-projection apparatus array system and a holographic function screen. But in an actual operation process, matching and control over the imaging quality of each single photography-projection device and the anchoring and calibrating of the array photography-projection apparatus cause difficulty to system integration; and meanwhile, massive use of a photography-projector will certainly increase a manufacturing cost of the system and is thus not likely to be accepted by common consumers.

### SUMMARY

Aiming at the defects of the prior art, the present application provides holographic three-dimensional display system and method.

In order to realize the object above, the present application adopts following technical solutions:

a holographic three-dimensional display system comprises a spatial spectrum parallel collecting apparatus, a spatial spectrum holographic coding apparatus and a discrete spatial spectrum restoring apparatus;

the spatial spectrum parallel collecting apparatus includes:

an information collecting lens array panel having M*N lenses with parallel optical axes, wherein, M and N are integers larger than 1, the information collecting lens array panel is used for performing M*N spatial spectrum image Iₘₙ sampling collecting on an object O to be three-dimensionally displayed, m is from 1 to M, n is from 1 to N, a spatial sampling angle is ωₘₙ=d₁/l₁, d1 is a center distance between all lenses and l₁ is a distance between the information collecting lens array panel and the object O;

a photosensitive element array, which is arranged at one side of the information collecting lens array panel opposite to the object, has M*N photosensitive elements, and is used for recording the spatial spectrum image Iₘₙ collected by each lens, wherein a resolution of each photosensitive element is not smaller than a preset number J*K of hoxels Hⱼₖ, of the object O in an object space, J and K are integers larger than 1, and the spatial spectrum image Iₘₙ is represented as Iₘₙ(j, k), j is from 1 to J and k is from 1 to K;

the spatial spectrum holographic coding apparatus performs holographic coding on M*N spatial spectrum image Iₘₙ(j, k), wherein for one hoxel Hⱼₖ of the object O, the (j, k)th pixel Pₘₙⱼₖ in each spatial spectrum image Iₘₙ(j, k) is sequentially combined into one M*N array image Sⱼₖ as a holographic coding image of the hoxel Hⱼₖ, and in this way, the spatial spectrum holographic coding image Sⱼₖ(m, n) of the J*K hoxels of the object O is obtained;

the discrete spatial spectrum restoring apparatus includes:

a flat panel display, used for displaying the J*K spatial spectrum holographic coding image Sⱼₖ(m, n) subjected to proper zooming, and having a resolution not lower than M*N*J*K;

an information restoring lens array panel, having J*K lenses with parallel optical axes and consistent imaging parameters, and used for restoring each spatial spectrum holographic coding image Sⱼₖ(m, n) on the flat panel display into a three-dimensional image O′ consisting of a discrete spatial spectrum Iₘₙ(j, k) of the object O;

a holographic function screen, which is arranged at one side of the information restoring lens array panel opposite to the flat panel display, wherein the holographic function screen has a regularly distributed micro spatial structure, which causes each spatial spectrum holographic coding image Sⱼₖ(m, n) incident to the holographic function screen to have a corresponding spatial widening output, and a widening angle of each spatial spectrum holographic coding image Sⱼₖ(m, n) is the spatial sampling angle ωₘₙ, thereby causing each spatial spectrum holographic coding image Sⱼₖ(m, n) to be joined with each other without overlapping coverage, so as to form a complete continuous spatial spectrum output,

wherein, the spatial sampling angle ωₘₙ=d₁/l₁=d₂/l₂, d₂ is a center distance between all lenses of the information restoring array panel and l₂ is a distance between the information restoring lens array panel and the holographic function screen.

Further, the holographic three-dimensional display system further comprises an information collecting field diaphragm between the information collecting lens array panel and the photosensitive element, so as to reduce or eliminate imaging interference among respective lenses of the information collecting lens array panel.

Further, the holographic three-dimensional display system further comprises a restoring field diaphragm between the information restoring lens array panel and the holographic function screen so as to eliminate or reduce the imaging interference between all lenses of the information restoring lens array panel.

Further, a field of view Ω between each lens of the information collecting lens array panel and each lens of the information restoring lens array panel is equal, tan(Ω/2)=a₁/2f₁=a₂/2f₂, wherein a₁ is the aperture of each lens of the information collecting lens array panel, f₁ is a focus length of the each lens of the information collecting lens array panel, a₂ is the aperture of the information restoring lens array panel, and f₂ is a focus length of the information restoring lens array panel.

Further, a distance between the holographic function screen and the information collecting lens array panel is equal to a distance between a reference surface P_{R} in an object space of the hoxels of the object O and the object O or the zoomed in or zoomed out distance between the reference surface P_{R} and the object O.

Further, the center of the information collecting lens array panel at least has a lens capable of collecting a panorama of the object.

Further, each lens of the information restoring lens array panel is in a cellular array manner.

A holographic three-dimensional display method comprises a spatial spectrum parallel collecting process, a spatial spectrum holographic coding process and a discrete spatial spectrum restoring process;

the spatial spectrum parallel collecting process includes following steps:

performing M*N spatial spectrum image Iₘₙ, sampling collecting on an object O to be three-dimensionally displayed by an information collecting lens array panel, wherein the information collecting lens array panel has M*N lenses with parallel optical axes and consistent imaging parameters, M and N are integers larger than 1, m is from 1 to M, n is from 1 to N, a spatial sampling angle is ωₘₙ=d₁/l₁, d1 is a center distance between all lenses and l₁ is a distance between the information collecting lens array panel and the object O;

recording the spatial spectrum image Iₘₙ collected by each lens through a photosensitive element array, wherein the photosensitive element array is arranged at one side of the information collecting lens array panel opposite to the object and has M*N photosensitive elements, a resolution of each photosensitive element is not smaller than a preset number J*K of hoxels Hⱼₖ of the object O in an object space, J and K are integers larger than 1, and the spatial spectrum image Iₘₙ is represented as Iₘₙ(j, k), j is from 1 to J and k is from 1 to K;

the spatial spectrum holographic coding process comprises a step: performing holographic coding on M*N spatial spectrum image Iₘₙ(j, k), wherein for one hoxel Hⱼₖ of the object O, the (j, k)th pixel Pₘₙⱼₖ in each spatial spectrum image Iₘₙ(j, k) is sequentially combined into one M*N array image Sⱼₖ as a holographic coding image of the hoxel Hⱼₖ, and in this way, the spatial spectrum holographic coding image Sⱼₖ(m, n) of the J*K hoxels of the object O is obtained;

the discrete spatial spectrum restoring process includes following steps:

displaying the J*K spatial spectrum holographic coding image Sⱼₖ(m, n) subjected to proper zooming by a flat panel display, wherein the flat panel display has a resolution not lower than M*N*J*K;

restoring each spatial spectrum holographic coding image Sⱼₖ(m, n) on the flat panel display into a three-dimensional image O′ consisting of a discrete spatial spectrum Iₘₙ(j, k) of the object O by an information restoring lens array panel, wherein the information restoring lens array panel has J*K lenses a₂ with parallel optical axes and consistent imaging parameters; and

causing each spatial spectrum holographic coding image Sⱼₖ(m, n) incident to the holographic function screen to have a corresponding spatial widening output by a holographic function screen which is arranged at one side of the information restoring lens array panel opposite to the flat panel display and has a regularly distributed micro spatial structure, wherein a widening angle of each spatial spectrum holographic coding image Sⱼₖ(m, n) is the spatial sampling angle ωₘₙ, thereby causing each spatial spectrum holographic coding image Sⱼₖ(m, n) to be joined with each other without overlapping coverage, so as to form a complete continuous spatial spectrum output,

wherein, the spatial sampling angle ωₘₙ=d₁/l₁=d₂/l₂, d₂ is a center distance between all lenses of the information restoring array panel and l₂ is a distance between the information restoring lens array panel and the holographic function screen.

Further, the holographic three-dimensional display method further comprises a following step: eliminating or reducing imaging interference among respective lenses of the information collecting lens array panel by an information collecting field diaphragm between the information collecting lens array panel and the photosensitive element.

Further, the holographic three-dimensional display method further comprises a following step: eliminating or reducing imaging interference between all lenses of the information restoring lens array panel by a restoring field diaphragm between the information restoring lens array panel and the holographic function screen.

Further, a field of view Ω between each lens of the information collecting lens array panel and each lens of the information restoring lens array panel is equal, tan(Ω/2)=a₁/2f₁=a₂/2f₂, wherein a₁ is the aperture of each lens of the information collecting lens array panel, f₁ is a focus length of the each lens of the information collecting lens array panel, a₂ is the aperture of the information restoring lens array panel, and f₂ is a focus length of the information restoring lens array panel.

Further, a distance between the holographic function screen and the information collecting lens array panel is equal to a distance between a reference surface P_{R} in an object space of the hoxels of the object O and the object O or the zoomed in or zoomed out distance between the reference surface P_{R} and the object O.

Further, the center of the information collecting lens array panel at least has a lens capable of collecting a panorama of the object.

Further, each lens of the information restoring lens array panel is in a cellular array manner.

According to the present application, by using the lens arrays and the holographic function screen, an inherent conflict between the imaging quality of a microlens array and the resolution of a displayed three-dimensional image in integration photography is effectively overcome, eye visible perfect true three-dimensional display is realized, and it is equivalent to that each photography-projection apparatus in WO2010/072067 is anchored at infinity. One key point is that plane pixel information (J*K*M*N) of the flat panel display is reasonably used to convert the discrete spatial spectrum image information Iₘₙ into the discrete spatial spectrum image Sⱼₖ by using holographic coding conversion, the discrete spatial spectrum thereof is restored by using corresponding lens arrays, and the discrete spectrum widening of the sampling angle ωₘₙ is realized by the holographic function screen in WO2010/072067 so as to realize complete spatial spectrum restoring of an original three-dimensional space.

(1) the spatial spectrum digital holographic coding Sⱼₖ of certain hoxel Hⱼₖ in an original space is obtained by using the collected spatial spectrum image Iₘₙ, spectrum-image coordinate conversion is effectively realized, and according to a fake visual defect of the traditional integration photography, the discrete spatial spectrum restoring of the original space is perfectly realized.

(2) the coding is suitable for a three-dimensional restoring system of any form, the generated holographic coding image Sⱼₖ(m, n) can be directly applied to lens array imaging, or used as hagel input of a Fourier transform hologram for performing three-dimensional image printing point by point.

(3) by simply zooming the spatial spectrum image Sⱼₖ, the size of any hoxel Hjk can be freely changed to realize the zooming in or out display of a three-dimensional object.

(4) a maximal spatial spectrum sampling angle ωₘₙ required by completely restoring the space is designed according to specific requirements (such as resolution, field depth and observation angle), thus perfectly restoring the displayed three-dimensional space with the least spatial spectrum number (M, N).

### BRIEF DESCRIPTION OF THE DRAWINGS

FIG. 1 is a schematic diagram of spatial spectrum parallel collecting according to an embodiment of the present application;

FIG. 2 is a schematic diagram of spatial spectrum images collected by anchoring in WO2010/072065, WO2010/072066 and WO2010/072067, wherein the position of a reference point R in each spatial spectrum image is same;

FIG. 3 is a schematic diagram of a spatial spectrum image parallelly collected by an embodiment of the present application, wherein a reference point R_{m n} is moved in parallel by a bit image factor δₘₙ relative to FIG. 2;

FIG. 4 is a schematic diagram of a holographic coding image S_{j k} of a hoxel H_{j k} according to an embodiment of the present application;

FIG. 5 is a schematic diagram of complete discrete spatial spectrum coding of a three-dimensional object O according to an embodiment of the present application;

FIG. 6 is a schematic diagram of discrete spatial spectrum restoring according to an embodiment of the present application;

FIG. 7 is a schematic diagram of decoding reappearing of a holographic function screen according to an embodiment of the present application;

FIG. 8 is a schematic diagram of lens arraying according to an embodiment of the present application;

FIG. 9 is a schematic diagram of a holographic spatial spectrum according to an application example of the present application;

FIG. 10 is pictures of three-dimensional display of an application example shot in upper, lower, left and right directions; and

FIG. 11 is a schematic diagram of a holographic three-dimensional display system according to an embodiment of the present application.

### DETAILED DESCRIPTION

The embodiments of the present application are described in further detail below with reference to the accompanying drawings. Although the present application is described, following examples are provided to specifically explain and clearly understand the embodiments of the present application. It is obvious for persons of ordinary skill in the art that certain change and modification can be made on these described embodiments and such change and modification do not depart from the spirit of the present application.

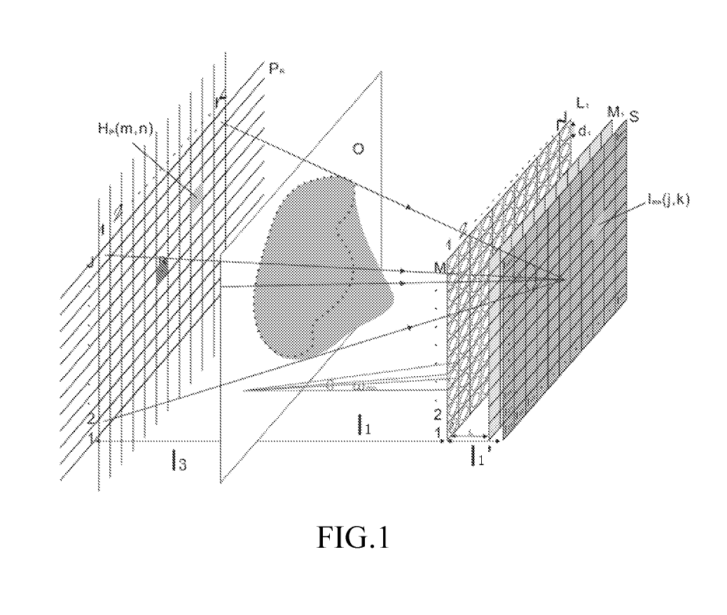

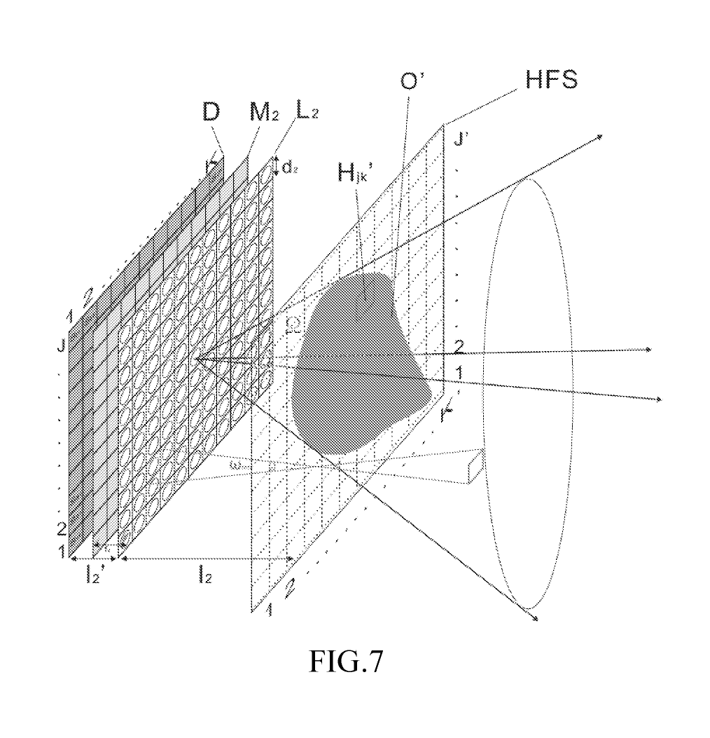

Referring to FIG. 1, FIG. 7 and FIG. 11, according to an embodiment of the present application, a holographic three-dimensional display system comprises a spatial spectrum parallel collecting apparatus 100, a spatial spectrum holographic coding apparatus 200 and a discrete spatial spectrum restoring apparatus 300.

FIG. 1 illustrates that the spatial spectrum parallel collecting apparatus performs spatial spectrum information collecting. The spatial spectrum parallel collecting apparatus comprises an information collecting lens array panel L₁ and a photosensitive element array S. The information collecting lens array panel L₁ is a lens array panel consisting of M*N small lenses with consistent imaging parameters, and optical axes of all lenses are parallel. Each lens has an aperture of a₁, a focus length of f₁ and a center distance of d₁, and a field of view of each single lens is Ω and meets tan (Ω/2)=a₁/2 f₁. For a three-dimensional object O in the effective visual angle Ω of each single lens, spatial spectrum information Iₘₙ(m is from 1 to M and n is from 1 to N) collected by each lens is same as that described in WO2010/072065, WO2010/072066 and WO2010/072067, and a sampling angle is ωₘₙ=d₁/l₁, wherein, l₁ is a distance between the information collecting lens array panel L₁ and the object O.

The photosensitive element array S can adopt a color film, CCD, CMOS etc. The photosensitive element array S can be placed at a position, away from the lens array panel by l₁′, nearby a rear focus point of the lens array panel L₁, to record the spatial spectrum information Iₘₙ(j, k) collected by each lens, l₁ and l₁′ are in an object image conjugation relation of each single lens. The resolution of each photosensitive element is not smaller than a preset number J*K of hoxels Hⱼₖ of the object O in an object space, J and K are integers larger than 1, j is from 1 to J and k is from 1 to K. The object spatial hoxel corresponding to the object O is Hⱼₖ, that is: the collected three-dimensional object O consists of hoxels (Hoxel) Hⱼₖ. A distance between a reference plane P_{R} of the hoxels Hⱼₖ and the object O is l₃, and a reference point R is located at the center position of the reference plane. In order to prevent mutual interference of information obtained by each lens on the photosensitive element array S, a field diaphragm M₁ is arranged between the photosensitive element array S and the information collecting lens array panel L₁, to prevent mutual interference of imaging Iₘ of each lens.

Compared with traditional integration photography, the lens array is not required as a microlens array, and the size a₁ of the aperture can be adopted as long as a clear spatial spectrum view is collected. The clear spatial spectrum view means that each pixel in a common photographic image corresponds to certain clear point in a shot three-dimensional space. It is same as a field depth concept of common photography, that is, the smaller the aperture a₁, the larger the field depth of the shot picture. Speaking from this angle, the smaller the a₁, the clearer the collected spatial spectrum view. Due to influence of an aperture diffraction effect, a resoluted minimum distance is increased, and an imaging quality is obviously reduced, which is a fundamental reason why the traditional integration photography cannot obtain a satisfactory result. In addition, the aperture a₁ and focus length f₁ of the lens decide the field of view Ω of each lens, the larger the Ω, the larger a field range of a collected three-dimensional target. In WO2010/072065, WO2010/072066 and WO2010/072067, due to anchoring collecting, each lens can collect a spatial spectrum of such three-dimensional target panorama, while in parallel collecting of the present embodiment, a scene of the collected target is cut by the inherent field of view Ω, therefore, the lens possibly cannot collect the spatial spectrum of the three-dimensional target panorama. In the present embodiment, at least one lens nearby by the center (M/2, N/2) of the lens array can collect the panorama of the object O (j, k).

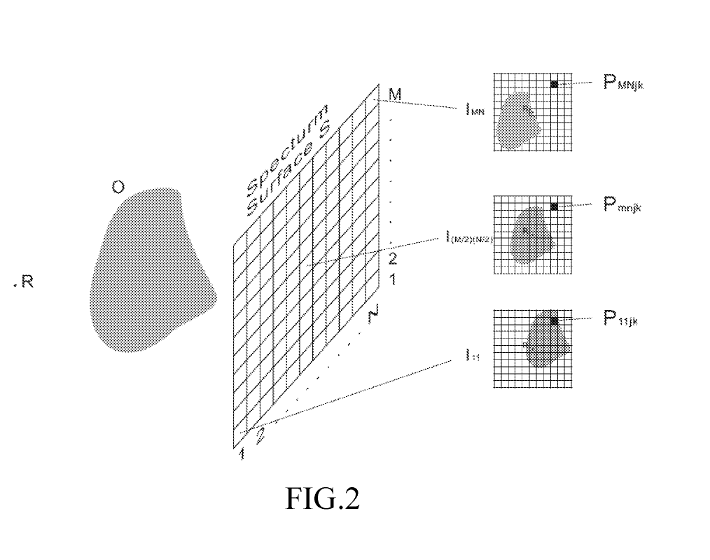

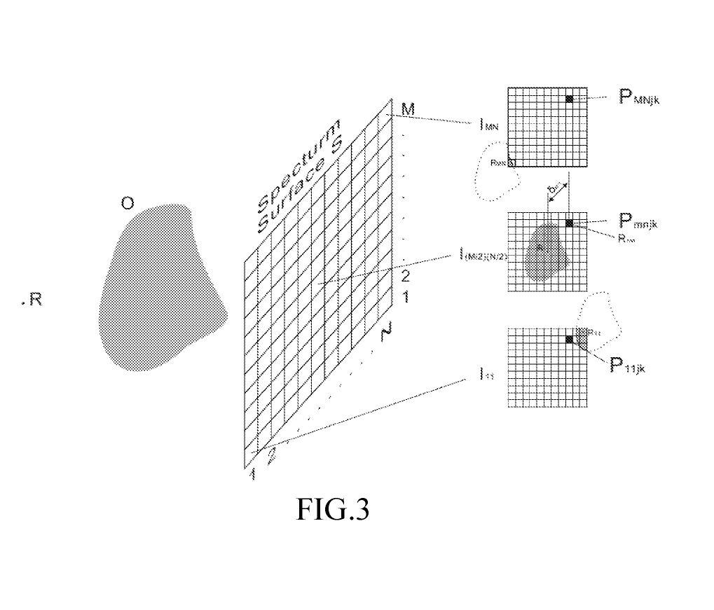

Compared with the anchoring collecting disclosed in WO2010/072065, WO2010/072066 and WO2010/072067, except the exact same I_{(M/2)(N/2)}(j, k) of each spatial spectrum image, it is equivalent to that original anchoring collecting respective spatial spectrum images Iₘₙ (j, k) of other respective images are cut by the field diaphragm M₁ after translating by a phase factor δₘₙ on a spectrum surface S, which causes a reference point Rₘₙ of the original object O to still be overlapped at the same position in the original space after imaging restoring by each lens, and Rₘₙ is a corresponding coordinate of a reference point R in each spatial spectrum image Iₘₙ, and is as shown in FIG. 2 and FIG. 3. The phase factor δₘₙ is an inherent property of the parallel collecting of the present application, and can also serve as a coordinate translating basis of the spatial spectrum image under a condition of anchoring collecting parallel playing or parallel collecting anchoring playing.

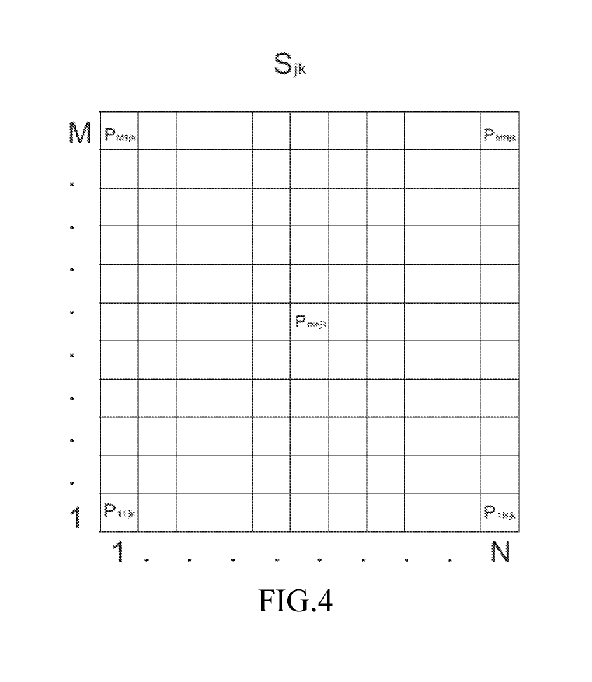

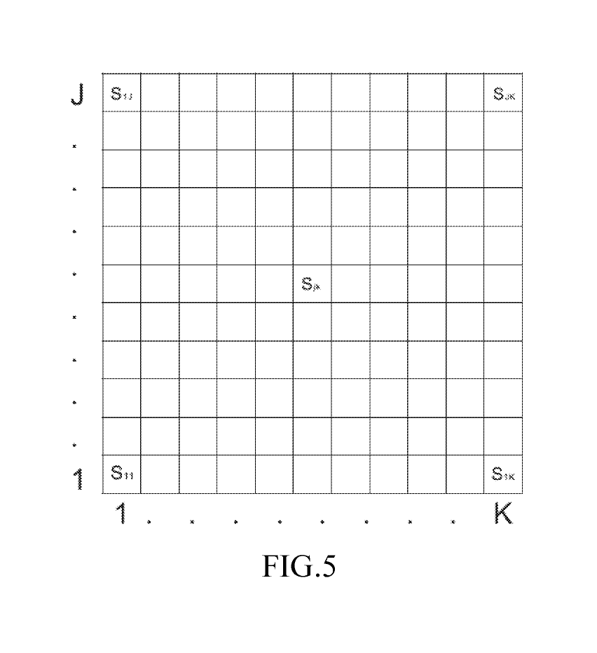

FIG. 4 and FIG. 5 illustrate a spatial spectrum holographic coding apparatus, for example a computer (not shown), which performs holographic coding on the collected M*N spatial spectrum images Iₘₙ(j, k) with the pixels of J*K to obtain J*K spatial spectrum holographic coding images Sⱼₖ (m, n). A specific operation comprises: as shown in FIG. 4, filling the (j, k) th pixel Pₘₙⱼₖ in the Iₘₙ(j, k) into certain hoxel Hⱼₖ, in the original space in FIG. 1 to obtain the spatial spectrum image Sⱼₖ of the hoxel.

As shown in FIG. 1, the collecting lens array collects the spatial spectrum from the right side of the object O, a basic principle of the traditional integration photography is to restore the collected spatial spectrum image to the object by the original lens panel, therefore, when the restored object is observed from the left side, a fake view is saw, that is, a stereo relation is opposite to that of the original object. A reference plane P_{R} is established at the left side of the object O, a restored three-dimensional space from the reference plane P_{R} after information coding is just the reversal of the original fake view, that is, an envisaged restored image is saw, and a stereo relation is same as that of the original object. Therefore, by the spatial spectrum image Sⱼₖ of the original space certain hoxel Hⱼₖ, obtained by the collected spatial spectrum image Iₘₙ collected in FIG. 1, spectrum-image coordinate conversion can be effectively realized to eradicate the fake view defect of the original integrated photography. A meaning of the spectrum-image coordinate conversion is explained in a manner that the original M*N spatial spectrum images can be represented as the spatial spectrum view of the original object in M*N directions, and the spatial spectrum image Sⱼₖ is the hoxel coding of these view elements in the restored space, that is, each hoxel Hⱼₖ contains the information Sⱼₖ of the original object in each direction.

As shown in FIG. 5, for each hoxel Hⱼₖ in FIG. 1, the J*K spatial spectrum image Sⱼₖ as shown in FIG. 4 are displayed on the flat panel display D after simple zooming treatment, a resolution of the flat panel display D is not smaller than M*N*J*K, thus displaying a complete discrete spatial spectrum coding pattern on the flat panel display D.

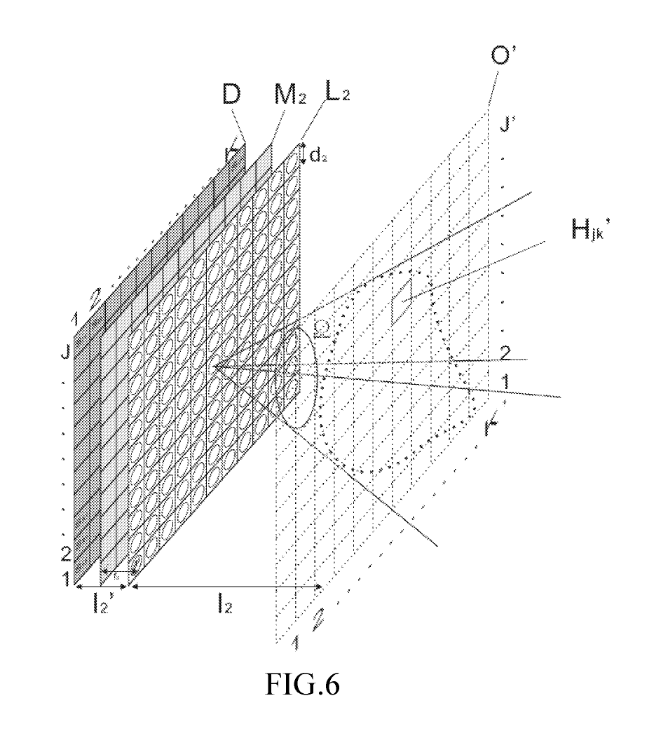

As shown in FIG. 6 to FIG. 7, the discrete spatial spectrum restoring apparatus comprises a flat panel display D, an information restoring lens array panel L₂ and a holographic function screen HFS. FIG. 6 illustrates that the discrete spatial spectrum restoring apparatus restores a discrete spatial spectrum. The information restoring lens array panel L₂ is placed at the position away from the front surface of the flat panel display D by a distance of l₂′. The information restoring lens array panel L₂ is an array lens array panel consisting of J*K small lenses with consistent imaging parameters, and each lens has an aperture of a₂ and a center distance of d₂ (which is just the size of the hoxel to be restored). A field diaphragm M₂ is placed between the D and the information restoring lens array lens L₂ to avoid the mutual interference of images of respective single lenses.

Preferably, a field of view (FOV) of each lens of the information restoring lens array panel L₂ is same as that of each lens of the information collecting lens array panel L₁ and is also Ω. If the field of view is different, distortion of a three-dimensional space will be caused. Each piece of spatial spectrum coding information Sⱼₖ (m, n) on the flat panel display D is projected and restored by the information restoring lens array panel L₂ to the three-dimensional image O′ consisting of the discrete spatial spectrum Iₘₙ, (j, k) of the original three-dimensional object O, and a number of hoxels Hⱼₖ′ is J′*K′. The size of J′*K′ is decided by following factors: 1. the size of each pixel in Sₖ is Δ_{D}, that is the pixel size of the flat panel display; 2. after the Sⱼₖ is imaged by the small lenses in the information restoring lens array panel L₂, the size thereof is amplified by M times, and the size of a corresponding hoxel is MΔ_{D}; 3. it is assumed that the length and width of the flat panel display are a and b respectively, then, J′=a/MΔ_{D},K′=b/MΔ_{D}. It can be seen that J′*K′ is not directly related to the J*K, and is the number of final hoxels Hⱼₖ′ formed by accumulating the spatial spectrum coding image Sⱼₖ projected by the hoxels Hⱼₖ, in the spatial M*N directions in an area a*b of the display, namely the final holographic display hoxel resolution. Similarly, compared with traditional integration photography, the information restoring lens array panel L₂ is not required to be the microlens array, the size of each lens aperture a₂ takes a condition of clearly restoring each spatial spectrum image Sⱼₖ (m, n) as a principle, resolution and clear imaging Δ_{D} are realized, however a too small aperture a₂ should be avoided to avoid speckle noise. In addition, in principle, the larger the field of view Ω of each single lens, the more the number (M,N) of the clearly resoluted discrete spatial spectrums, and the larger of the field of view of a restored three-dimensional object.

As shown in FIG. 7, in a position O′ away from the information restoring lens array panel L₂ by a distance of l₂, the holographic function screen disclosed in WO2010/072065 WO2010/072066 and WO2010/072067 is placed, so that a widening angle of the holographic function screen relative to each input spatial spectrum Sⱼₖ is the spatial sampling angle ωₘₙ as shown in FIG. 1, that is, respective discrete spatial spectrum coding Sⱼₖ are joined with each other without overlapping (represented in a manner that the edge of each lens is just blurred to become an integral bright background), and form complete continuous spatial spectrum output, and human eyes can observe the holographic true three-dimensional image of the O′ by the HFS in the field of view Ω. The size of the hoxel Hⱼₖ′ is just corresponding amplification of each pixel Sⱼₖ (m, n).

As shown in FIG. 1 and FIG. 7, the spatial sampling angle ωₘₙ=d₁/l₁=d₂/l₂. In FIG. 7, l₁ are l₁′ are in an object image conjugation relation of each single lens on the information restoring lens array panel L₂. In FIG. 6 and FIG. 7, the distance l₂ between the information restoring lens array panel L₂ and the O′ of the holographic function screen and the distance l₃ between the reference plane P_{R} and the object O in FIG. 1 are equal (which is not required that O′ of the holographic function screen is strictly at the distance, the holographic function screen can decode nearby and only an image surface changes), or a distance l₃ between the reference surface P_{R} and the object O is zoomed in or out (that is the distance l₃ corresponding to the zoomed in or out object in FIG. 1)

Imaging Quality Analysis

1. Spatial Spectrum Description of Three-Dimensional Spatial Information

It is assumed that the hoxel of a three-dimensional space is Δⱼₖ, the depth of the three-dimensional space is AZ, a corresponding spatial sampling angle is ωₘₙ=Δⱼₖ/ΔZ. That is to say: a three-dimensional object consisting of J*K*ΔZ*Δⱼₖ independent small cubes with a volume of Δⱼₖ³ can be totally expressed by M*N*J*K wedge light beams, and a peak of the wedge light beams is positioned at the plane of the holographic function screen HFS, and a divergence angle is ωₘₙ.

An observation field of view of the three-dimensional object is

$$Ω = {\sum }_{m = 1}^{M} {\sum }_{n = 1}^{N} {ω}_{mn}$$

herein, ΔZ*Δⱼₖ=Δⱼₖ*Δⱼₖ/ωₘₙ=M*N, since the hoxel contains M*N spatial spectrums.

2. Spatial Spectrum Description of Eye Vision

Basic parameters of eyes are as follows: (1) an interpupillary distance (average distance between two eyes): d is about 6.5 mm; (2) pupil diameter (which is 2-8 mm and related to brightness), an average value is a which is about 5 mm; (3) an angle limit of resolution: ω_{E} is about 1.5*10⁻⁴; and (4) a fixed point static field of viewΩ_{E} is about 90°.

It can seen that when positions of double eyes are fixed, an eye vision can be expressed as a double eye parallax stereoscopic image consisting of about J*K=(Ω_{E}/ω_{E}) ²≈[(π/2)/1.5*10⁻⁴]²≈10⁸ hoxels and two spatial spectrums (M*N=2). Another physical meaning is that in nature, two hoxels H _{left eye} and H _{right eye} at fixed positions of the eyes contain and receive the 10⁸ spatial spectrums, thus forming a three-dimensional objective knowledge of the eyes immersed in a hoxel sea for the nature.

3. Effective Collecting and Restoring of Spatial Three-Dimensional Information

Aiming at the spatial expressing on the visible three-dimensional spatial information described by first and second points, complete collecting can be realized by using the lens array panel as shown in FIG. 1 and complete restoring can be realized by using the lens array panel as shown in FIG. 6. Related parameters have a following relation: a₁=2λl₁/Δⱼₖ, a₂=2λl₂/Δⱼₖ, λ is visible light average wavelength and about 550 nm; ωₘₙ=d₁/l₁=d₂/l₂; tan (Ω/2)=a₁/2f₁=a₂/2f₂. Here, the size of the aperture of the lens decides the size Δⱼₖ of the hoxel capable of being collected and restored, a center distance of the lens decides the spatial sampling angle ωₘₙ capable of being collected and restored, thereby deciding the field of depth ΔZ=Δⱼₖ/ωₘₙ to be collected and restored, the focus length of the lens decides a field of view Ω of the three-dimensional spatial information, which is represented as a processing capacity of the lens unit for the three-dimensional spatial information spatial spectrum.

Namely:

$$Ω = {\sum }_{m = 1}^{M} {\sum }_{n = 1}^{N} {ω}_{mn}$$

the key point is that the photosensitive and display device (the photosensitive element array S in FIG. 1 and the flat panel display D in FIG. 6) with corresponding resolutions are arranged to resolute and display the spatial spectrum information consisting of the J*K*M*N plane pixels.

### Application Examples

A current commercial 4K flat panel display is used to realize the total color total parallax digital holographic three-dimensional restoring displaying according to above principle, and specific display parameters are as follows: 1, a size of the hoxels Hⱼₖ′ is 4 mm*4 mm; 2, a number of the hoxels Hⱼₖ′ is J′*K′=211*118; 3, a number of spatial spectrums is M*N=36*36; and 4, an spatial observation angle is Ω=30°, and a display field of depth is about 50 cm.

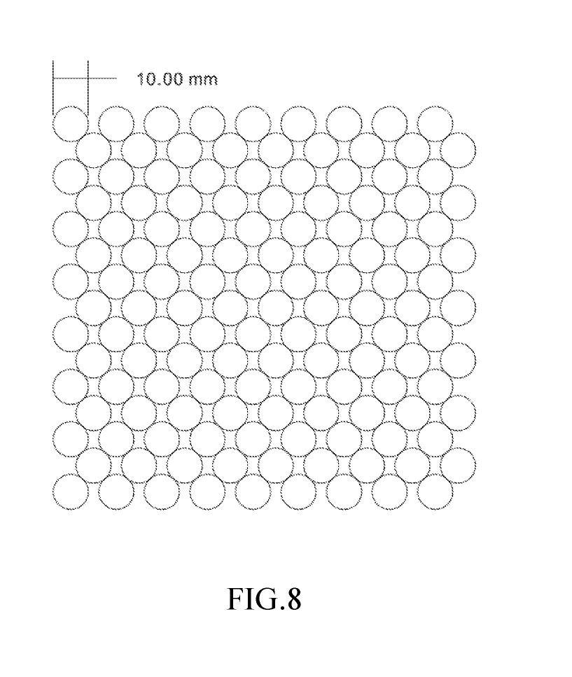

FIG. 8 is a schematic diagram of an adopted lens array, and in order to make full use of the information capacity of finite plane pixels of the display, 3818 small lenses with a diameter of 10 mm are arrayed in a cellular arraying manner.

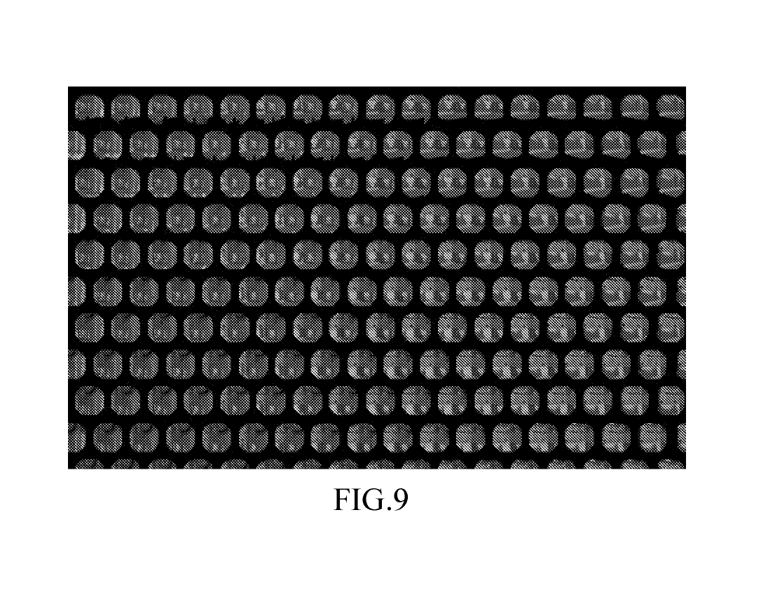

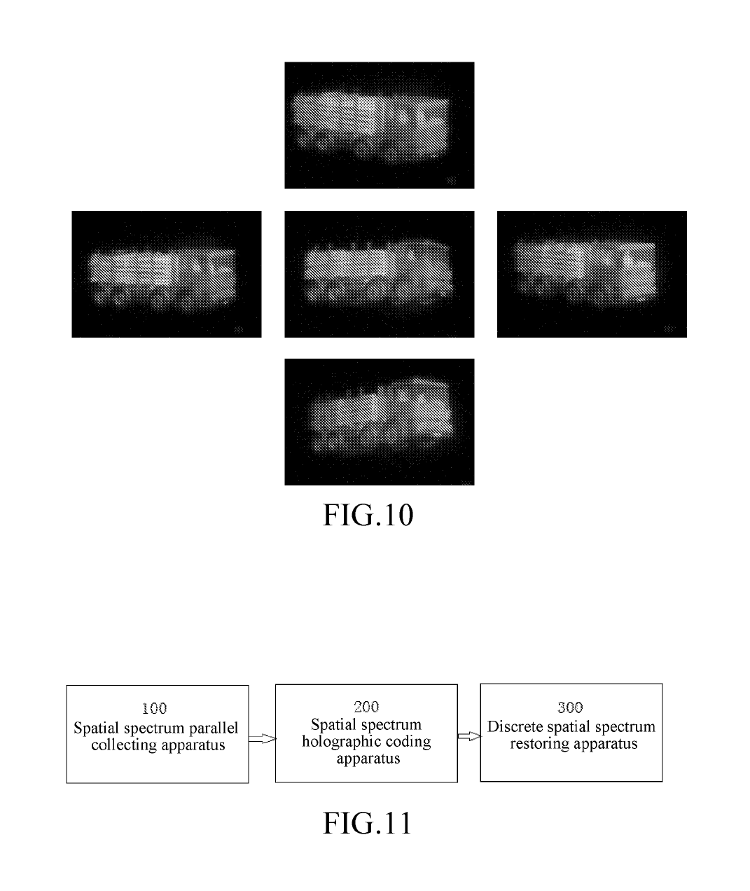

FIG. 9 is a holographic spatial spectrum coding schematic diagram in each small lens, an entity information collecting step is replaced with rendering of a computer virtual three-dimensional model, and a coding image is only limited to a head end cockpit part. FIG. 10 is pictures of three-dimensional display of a truck shot in upper, lower, left and right directions.

In order to improve display resolution, two following solutions can be used:

1, Spatial Splicing of a Plurality of 4K Displays is Used for Realizing Large-Area Three-Dimensional Holographic Display.

At current, display of 4 mm hoxels is equivalent to a display resolution of an large LED screen, but the present application adopts hoxel display, and each pixel consists of M*N (36*36) light beams, thereby realizing true three-dimensional large-area display. In the present example, if same 3*4 4K screens are spliced, three-dimensional display with a plane resolution of 633*472 and display space 2.5 m*1.9 m*0.5 m of can be obtained, and is equivalent to that 4 mm³ display points use build blocks in a display space.

2. High Resolution Holographic Display Realized by Using High Resolution Flat Panel Display

It is easy to imagine that if a 8K, 16K and even 32K flat panel display is used, then common resolution and even high resolution holographic display can be realized by using a basic principle of the present application. Actually, when an eyepiece system of the current optical microscope is matched with a corresponding sampling angle ωₘₙ, an ideal holographic three-dimensional display instrument can be manufactured.

Above described details only intend to facilitate understanding, any unnecessary should not be understood therefrom, and modification on the specification is obvious for those skilled in the art. Although the present application is described in combination with specific embodiments, but further modification should be understood, the present application intends to cover any variants, application or adjustments basically based on the principle of the present application, and comprises such extended content, that is, the content is in a known or conventional practice range of the involved field, can use the basic features provided in above specification and conforms with a range of the appended claims.

Although describing and specifically instantiating some preferable embodiments of the present application, the specification is not intended to limit the present application to such embodiments, and any such limitation is only contained in the claims.

What is claimed is:

1. A holographic three-dimensional display system, characterized by comprising a spatial spectrum parallel collecting apparatus, a spatial spectrum holographic coding apparatus and a discrete spatial spectrum restoring apparatus, wherein
the spatial spectrum parallel collecting apparatus includes:
an information collecting lens array panel having M*N lenses with parallel optical axes and consistent imaging parameters, wherein, M and N are integers larger than 1, the information collecting lens array panel is used for performing M*N spatial spectrum image Iₘₙ sampling collecting on an object O to be three-dimensionally displayed, m is from 1 to M, n is from 1 to N, a spatial sampling angle is ωₘₙ=d₁/l₁, d1 is a center distance between all lenses and l₁ is a distance between the information collecting lens array panel and the object O;
a photosensitive element array, which is arranged at one side of the information collecting lens array panel opposite to the object, has M*N photosensitive elements and is used for recording the spatial spectrum image Iₘₙ collected by each lens, wherein a resolution of each photosensitive element is not smaller than a preset number J*K of hoxels Hⱼₖ of the object O in an object space, J and K are integers larger than 1, and the spatial spectrum image Iₘₙ is represented as Iₘₙ(j, k), j is from 1 to J and k is from 1 to K;
wherein the spatial spectrum holographic coding apparatus performs holographic coding on M*N spatial spectrum image Iₘₙ(j, k), wherein for one hoxel Hⱼₖ of the object O, the (j, k)th pixel Pₘₙⱼₖ in each spatial spectrum image Iₘₙ(j, k) is sequentially combined into one M*N array image Sⱼₖ as a holographic coding image of the hoxel and in this way, the spatial spectrum holographic coding image Sⱼₖ(m, n) of the J*K hoxels of the object O is obtained;
the discrete spatial spectrum restoring apparatus includes:
a flat panel display, used for displaying the J*K spatial spectrum holographic coding image S (m, n) subjected to proper zooming, and having a resolution not lower than M*N*J*K;
an information restoring lens array panel, having J*K lenses with parallel optical axes and consistent imaging parameters, and used for restoring each spatial spectrum holographic coding image Sⱼₖ(m, n) on the flat panel display into a three-dimensional image O′ consisting of a discrete spatial spectrum Iₘₙ(j, k) of the object O; and
a holographic function screen, which is arranged at one side of the information restoring lens array panel opposite to the flat panel display, wherein the holographic function screen has a regularly distributed micro spatial structure, which causes each spatial spectrum holographic coding image Sⱼₖ(m, n) incident to the holographic function screen to have a corresponding spatial widening output, wherein a widening angle of each spatial spectrum holographic coding image Sⱼₖ(m, n) is the spatial sampling angle ωₘₙ, thereby causing each spatial spectrum holographic coding image Sⱼₖ(m, n) to be joined with each other without overlapping coverage, so as to form a complete continuous spatial spectrum output,
wherein, the spatial sampling angle ωₘₙ=d₁/l₁=d₂/l₂, d₂ is a center distance between all lenses of the information restoring array panel and l₂ is a distance between the information restoring lens array panel and the holographic function screen.

2. The holographic three-dimensional display system according to claim 1, characterized by further comprising: an information collecting field diaphragm between the information collecting lens array panel and the photosensitive element, so as to reduce or eliminate imaging interference among respective lenses of the information collecting lens array panel.

3. The holographic three-dimensional display system according to claim 1, characterized by further comprising a restoring field diaphragm between the information restoring lens array panel and the holographic function screen so as to eliminate or reduce the imaging interference between all lenses of the information restoring lens array panel.

4. The holographic three-dimensional display system according to claim 1, characterized in that a field of view Ω between each lens of the information collecting lens array panel and each lens of the information restoring lens array panel is equal, tan(Ω/2)=a₁/2f₁=a₂/2f₂, wherein a₁ is the aperture of each lens of the information collecting lens array panel, f₁ is a focus length of the each lens of the information collecting lens array panel, a₂ is the aperture of the information restoring lens array panel, and f₂ is a focus length of the information restoring lens array panel.

5. The holographic three-dimensional display system according to claim 1, characterized in that a distance between the holographic function screen and the information collecting lens array panel is equal to a distance between a reference surface P_{R} in an object space of the hoxels of the object O and the object O or the zoomed in or zoomed out distance between the reference surface P_{R} and the object O.

6. The holographic three-dimensional display system according to claim 1, characterized in that the center of the information collecting lens array panel at least has a lens capable of collecting a panorama of the object.

7. The holographic three-dimensional display system according to claim 1, characterized in that each lens of the information restoring lens array panel is in a cellular array manner.

8. The holographic three-dimensional display system according to claim 2, characterized in that each lens of the information restoring lens array panel is in a cellular array manner.

9. The holographic three-dimensional display system according to claim 3, characterized in that each lens of the information restoring lens array panel is in a cellular array manner.

10. The holographic three-dimensional display system according to claim 4, characterized in that each lens of the information restoring lens array panel is in a cellular array manner.

11. The holographic three-dimensional display system according to claim 5, characterized in that each lens of the information restoring lens array panel is in a cellular array manner.

12. The holographic three-dimensional display system according to claim 6, characterized in that each lens of the information restoring lens array panel is in a cellular array manner.

13. A holographic three-dimensional display method, characterized by comprising: a spatial spectrum parallel collecting process, a spatial spectrum holographic coding process and a discrete spatial spectrum restoring process;
the spatial spectrum parallel collecting process includes following steps:
performing M*N spatial spectrum image Iₘₙ sampling collecting on an object O to be three-dimensionally displayed by an information collecting lens array panel, wherein the information collecting lens array panel has M*N lenses with parallel optical axes and consistent imaging parameters, M and N are integers larger than 1, m is from 1 to M, n is from 1 to N, a spatial sampling angle is ωₘₙ=d₁/l₁, d1 is a center distance between all lenses and l₁ is the distance between the information collecting lens array panel and the object O;
recording the spatial spectrum image Iₘₙ collected by each lens through a photosensitive element array, wherein the photosensitive element array is arranged at one side of the information collecting lens array panel opposite to the object and has M*N photosensitive elements, a resolution of each photosensitive element is not smaller than a preset number J*K of hoxels Hⱼₖ of the object O in an object space, J and K are integers larger than 1, and the spatial spectrum image Iₘₙ is represented as Iₘₙ(j, k), j is from 1 to J and k is from 1 to K; and
the spatial spectrum holographic coding process comprises a step: performing holographic coding on M*N spatial spectrum image Iₘₙ(j, k), wherein for one hoxel Hⱼₖ of the object O, the (j, k)th pixel Pₘₙⱼₖ in each spatial spectrum image Iₘₙ(j, k) is sequentially combined into one M*N array image Sⱼₖ as a holographic coding image of the hoxel Hⱼₖ, and in this way, the spatial spectrum holographic coding image Sⱼₖ(m, n) of the J*K hoxels of the object O is obtained;
the discrete spatial spectrum restoring process includes following steps:
displaying the J*K spatial spectrum holographic coding image Sⱼₖ(m, n) subjected to proper zooming by a flat panel display, wherein the flat panel display has a resolution not lower than M*N*J*K;
restoring each spatial spectrum holographic coding image Sⱼₖ(m, n) on the flat panel display into a three-dimensional image O′ consisting of a discrete spatial spectrum Iₘₙ(j, k) of the object O by an information restoring lens array panel, wherein the information restoring lens array panel has J*K lenses a₂ with parallel optical axes and consistent imaging parameters; and
causing each spatial spectrum holographic coding image Sⱼₖ(m, n) incident to the holographic function screen to have a corresponding spatial widening output by a holographic function screen which is arranged at one side of the information restoring lens array panel opposite to the flat panel display and has a regularly distributed micro spatial structure, wherein a widening angle of each spatial spectrum holographic coding image Sⱼₖ(m, n) is the spatial sampling angle ωₘₙ, thereby causing each spatial spectrum holographic coding image Sⱼₖ(m, n) to be joined with each other without overlapping coverage, so as to form a complete continuous spatial spectrum output,
wherein, the spatial sampling angle ωₘₙ=d₁/l₁=d₂/l₂, d₂ is a center distance between all lenses of the information restoring array panel and l₂ is a distance between the information restoring lens array panel and the holographic function screen.

14. The holographic three-dimensional display method according to claim 13, characterized by further comprising a following step: eliminating or reducing imaging interference among respective lenses of the information collecting lens array panel by an information collecting field diaphragm between the information collecting lens array panel and the photosensitive element.

15. The holographic three-dimensional display method according to claim 13, characterized by further comprising a following step: eliminating or reducing imaging interference between all lenses of the information restoring lens array panel by a restoring field diaphragm between the information restoring lens array panel and the holographic function screen.

16. The holographic three-dimensional display method according to claim 13, characterized in that a field of view Ω between each lens of the information collecting lens array panel and each lens of the information restoring lens array panel is equal, tan(Ω/2)=a₁/2f₁=a₂/2f₂, wherein a₁ is the aperture of each lens of the information collecting lens array panel, f₁ is a focus length of the each lens of the information collecting lens array panel, a₂ is the aperture of the information restoring lens array panel, and f₂ is a focus length of the information restoring lens array panel.

17. The holographic three-dimensional display method according to claim 13, characterized in that a distance between the holographic function screen and the information collecting lens array panel is equal to a distance between a reference surface P_{R} in an object space of the hoxels of the object O and the object O or the zoomed in or zoomed out distance between the reference surface P_{R} and the object O.

18. The holographic three-dimensional display method according to claim 13, characterized in that the center of the information collecting lens array panel at least has a lens capable of collecting a panorama of the object.

19. The holographic three-dimensional display method according to claim 13, characterized in that each lens of the information restoring lens array panel is in a cellular array manner.
